(19) United States
(12) Patent Application Publication
(10) Pub. No.: US 2024/0207810 A1
(43) Pub. Date: Jun. 27, 2024

(54) GAS-LIQUID REACTOR

(71) Applicant: ZHEJIANG UNIVERSITY OF TECHNOLOGY, Zhejiang (CN)

(72) Inventors: Yong NIE, Zhejiang (CN); Xiaojiang LIANG, Zhejiang (CN); Zhenyu WU, Zhejiang (CN); Jianan LUO, Zhejiang (CN); Jiawei MA, Zhejiang (CN); Wenhao Li, Zhejiang (CN)

(73) Assignee: ZHEJIANG UNIVERSITY OF TECHNOLOGY, Zhejiang (CN)

(21) Appl. No.: 18/357,170

(22) Filed: Jul. 24, 2023

(30) Foreign Application Priority Data
Dec. 21, 2022 (CN) 202211653379.7

(51) Int. Cl. B01J 19/18

(52) U.S. Cl. CPC B01J 19/1825; B01J 2219/00094

(57) ABSTRACT

A gas-liquid reactor is provided. The gas-liquid reactor includes a reactor housing, where an outer side of the reactor housing is provided with a heat exchange jacket device, and the reactor housing is provided with a liquid phase inlet, a gas phase inlet and a gas-liquid phase outlet, and is internally provided with an electric dispersion gas distributor in communication with the gas phase inlet, and the electric dispersion gas distributor is provided with needle electrodes; and row tubes are arranged above the electric dispersion gas distributor, lower ends of the row tubes are grounded, and upper ends of the row tubes are located below the gas-liquid phase outlet. The gas-liquid reactor is configured to continuously produce gas-liquid reaction, and a gas-phase material is dispersed by utilizing the needle electrodes to form micrometer-scaled bubbles to be premixed with a liquid-phase material, and then stably flows through the row tubes.

### CROSS-REFERENCE TO RELATED APPLICATION

This application claims the priority benefit of China application serial no. 202211653379.7, filed on Dec. 21, 2022. The entirety of the above-mentioned patent application is hereby incorporated by reference herein and made a part of this specification.

### TECHNICAL FIELD

The present invention relates to a novel gas-liquid reaction device, and in particular to a gas-liquid reactor for enhancing gas-liquid phase mass and heat transfer, which can be widely applied to gas-liquid heterogeneous strong exothermic reaction processes of ozonation, sulfonation, chlorination, etc.

### BACKGROUND

Gas-liquid mass transfer is a common technical means for the fields such as chemical production. Gas-liquid mass transfer aims to increase a gas-liquid contact area, so as to increase a gas-liquid reaction rate. According to different ways of gas-liquid contact, gas-liquid reactors can be mainly divided into bubble-type reactors (such as bubble towers, plate towers and mechanical stirring kettles), droplet-type reactors (such as spray towers, jet reactors and Venturi reactors), and liquid film-type reactors (such as packed towers and wetted-wall towers).

For gas-liquid heterogeneous strong exothermic reactions of ozonation, sulfonation, chlorination, etc., a mass transfer process usually controls an entire gas-liquid reaction process, which is mainly limited by a gas-liquid phase boundary area. Moreover, it is necessary to remove a large amount of reaction heat generated in the reaction process in time, so as to avoid the problem of “temperature runaway”. However, existing bubble towers, spray towers, packed towers, jet reactors, Venturi reactors, etc. still have the problems such as a small gas-liquid phase boundary area, low reaction heat transfer efficiency, high energy consumption, and difficult regulation.

### SUMMARY

In order to solve the defects of the prior art, the present invention provides a novel gas-liquid reactor having a simple and reasonable structure, a large phase boundary area, high mass transfer efficiency, a fast heat transfer rate, and low energy consumption. An objective of the present invention is to utilize an electric field dispersion technology coupled with a tubular reactor technology to enhance the gas-liquid phase mass and heat transfer, so as to enhance the reaction and heat transfer.

A gas-liquid reactor includes: a reactor housing and a heat exchange jacket device arranged on an outer side of the reactor housing, where a bottom and a top of the reactor housing are provided with a liquid phase inlet and a gas-liquid phase outlet respectively, a lower end of a middle of the reactor housing is provided with a gas phase inlet, the lower end of the middle of the reactor housing is internally provided with an electric dispersion gas distributor in communication with the gas phase inlet, an upper surface of the electric dispersion gas distributor is provided with several needle electrodes, centers of the needle electrodes are provided with air holes, row tubes are arranged above the electric dispersion gas distributor, lower ends of the row tubes are grounded, the needle electrodes are connected to high-voltage electrodes, and a gas-phase material enters an internal cavity of the electric dispersion gas distributor from the gas phase inlet, is dispersed by the needle electrodes to be mixed with a liquid-phase material, then stably flows through the row tubes, and finally flows out through the gas-liquid phase outlet.

The gas-liquid reactor is characterized in that the electric dispersion gas distributor is in a circular tube type cavity structure, the several needle electrodes are uniformly distributed on the upper surface of the electric dispersion gas distributor, the row tubes correspond to the needle electrodes one to one from top to bottom, and central axes of the row tubes and the needle electrodes that correspond to each other are located on the same vertical line.

The gas-liquid reactor is characterized in that the reactor housing includes an upper sealing head, a middle housing and a lower sealing head, where the gas phase inlet is provided at a lower portion of a side wall of the middle housing, an insulating layer is arranged on each side wall of the middle housing above and below the gas phase inlet, and the insulating layer above is arranged between the high-voltage electrode and the grounding electrode.

The gas-liquid reactor is characterized in that a diameter of the row tube is 5 times to 100 times a diameter of the needle electrode.

The gas-liquid reactor is characterized in that the row tube and the needle electrode are both made of conductive metals.

The gas-liquid reactor is characterized in that the row tube is internally filled with a packing.

The gas-liquid reactor is characterized in that the heat exchange jacket device includes a heat exchange interlayer arranged on an outer side of the middle housing, where a lower end and an upper end of the heat exchange interlayer are provided with a heat exchange medium inlet and a heat exchange medium outlet respectively.

The present invention has the beneficial effects:
1. The gas-liquid reactor disclosed in the present invention can be configured to continuously produce gas-liquid heterogeneous strong exothermic reactions. An electric field dispersion technology is organically integrated with a tubular reactor technology, and the reactor has the advantages of a large phase boundary area, low energy consumption, high heat and mass transfer efficiency, stable and controllable bubbles, difficult coalescence, convenient continuous production, etc.
2. By means of directional action by the electric field dispersion technology on a gas phase, the gas phase is independently and efficiently dispersed into “micrometer-scaled” charged bubbles having different diameters. For bubbles having a diameter of 400 micrometers, a volume specific surface area (6/d) can reach 15000 m²/m³, thereby greatly increasing a phase boundary area required for gas-liquid mass transfer. Compared with traditional jet flow and Venturi reactors utilizing high-speed flow of a liquid to disperse gas, energy consumption can be greatly reduced.
3. By means of a synergistic effect of the electric field dispersion technology and the tubular reactor technology, the charged microbubbles are stably and efficiently dispersed, and heat and mass transfer efficiency of the reactor is enhanced. On one hand, an electric field disperser generates micrometer-scaled bubbles having the same charge, and the micrometer-scaled bubbles can stably flow through a tubular reactor without coalescence under repulsive action of the same charge, and moreover, liquid disturbance can be enhanced, and heat and mass transfer efficiency of the tubular reactor can be further enhanced; and on the other hand, the tubular reactor improves residence time of the microbubble by means of turbulence and redispersion of the packing, enhances a disturbance effect of a liquid film on a surface of the microbubble, and enhances a mass transfer process of the microbubble while rapidly remove reaction heat.
4. The gas-liquid reactor disclosed in the present invention has a simple structure, convenient starting and stopping, easy industrial scale-up and excellent universality.

### BRIEF DESCRIPTION OF THE DRAWINGS

FIG. 1 is a schematic structural diagram of a gas-liquid reactor of the present invention;

FIG. 2 is a schematic diagram of a corresponding relation between a mass transfer coefficient and an enhanced mass transfer device in Example 1;

FIG. 3 is a schematic diagram of bubble dispersion in Example 1;

FIG. 4 is a graph of bubble particle size distribution of Example 1;

FIG. 5 is a graph of an ozonation reaction conversion rate and a temperature change of Example 2; and

FIG. 6 is a graph of an oxygen cracking reaction conversion rate and a temperature change of Example 3.

In the figures, 1—lower sealing head, 2—electric dispersion gas distributor, 3—insulating layer, 4—heat exchange medium inlet, 5—middle housing, 6—upper sealing head, 7—gas-liquid phase outlet, 8—heat exchange medium outlet, 9—row tube, 10—heat exchange interlayer, 11—gas phase inlet, 12—lower end of row tube, 13—needle electrode and 14—liquid phase inlet.

### DETAILED DESCRIPTION OF THE EMBODIMENTS

The present invention will be further described below in combination with particular examples, but the scope of protection of the present invention is not limited to the examples.

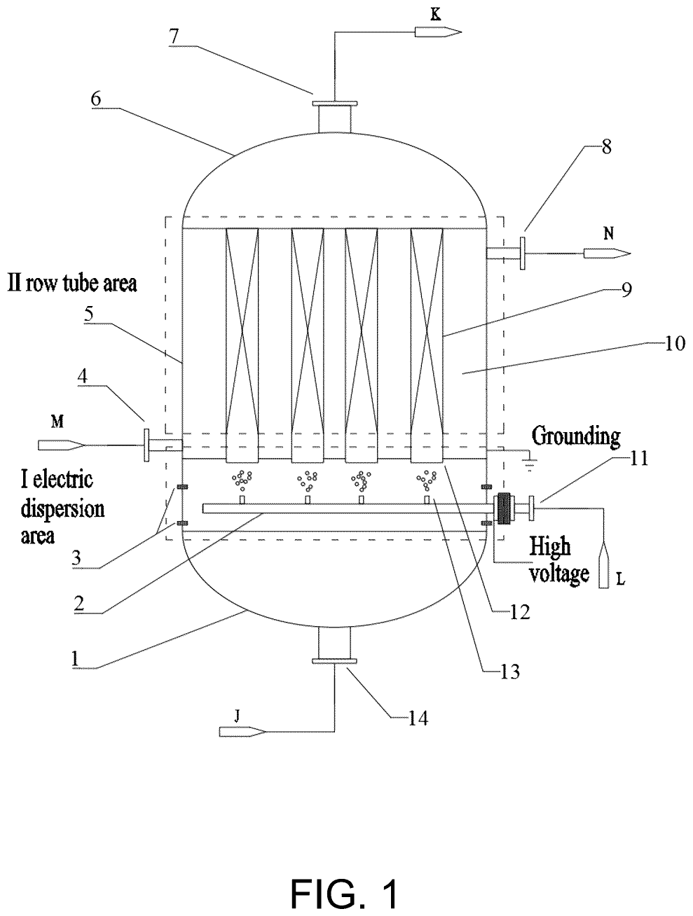

### Example: FIG. 1

A gas-liquid reactor includes: a reactor housing and a heat exchange jacket device arranged on an outer side of the reactor housing, where the reactor housing includes an upper sealing head 6, a middle housing 5 and a lower sealing head 1, and the heat exchange jacket device includes a heat exchange interlayer 10 arranged on an outer side of the middle housing 5, where a lower end and an upper end of the heat exchange interlayer 10 are provided with a heat exchange medium inlet 4 and a heat exchange medium outlet 8 respectively.

In FIG. 1, a top of the upper sealing head 6 is provided with a gas-liquid phase outlet 7, a bottom of the lower sealing head 1 is provided with a liquid phase inlet 14, a lower portion of a side wall of the middle housing 5 is provided with a gas phase inlet 11, a lower portion of the middle housing 5 is internally provided with an electric dispersion gas distributor 2 in communication with the gas phase inlet 11, the electric dispersion gas distributor 2 is in a circular tube type cavity structure, several needle electrodes 13 are uniformly distributed on an upper surface of the electric dispersion gas distributor 2, centers of the needle electrodes 13 are provided with air holes, the middle housing 5 is internally further provided with row tubes 9, and the row tubes 9 are arranged above the electric dispersion gas distributor 2.

In FIG. 1, the row tubes 9 correspond to the needle electrodes 13 one to one from top to bottom, central axes of the row tubes 9 and the needle electrodes 13 that correspond to each other are located on the same vertical line, and lower ends 12 of the row tubes are arranged close to an upper portion of the needle electrode 13. The lower ends 12 of the row tubes are grounded, the needle electrodes 13 are connected to high-voltage electrodes, and a gas-phase material enters an internal cavity of the electric dispersion gas distributor 2 from the gas phase inlet 11, is uniformly conveyed to the needle electrodes 13 at an upper portion of the electric dispersion gas distributor 2 from the internal cavity of the electric dispersion gas distributor 2 for dispersion to be mixed with a liquid-phase material, then stably flows through the row tubes 9, and finally flows out through the gas-liquid phase outlet 7.

In FIG. 1, an insulating layer 3 is arranged on each side wall of the middle housing 5 above and below the gas phase inlet 11, and the insulating layer 3 above is arranged between the high-voltage electrode and the grounding electrode.

A diameter of the row tube 9 is much larger than that of the needle electrode 13, and the diameter of the row tube 9 is 5 times to 100 times of that of the needle electrode 13. A non-uniform electrostatic field is formed in an area between the needle electrode 13 and the lower end 12 of the row tube to disperse the gas-phase material, so as to mix the gas phase and a liquid phase. The row tube 9 and the needle electrode 13 are both made of conductive metals. The row tube 9 is internally filled with a packing.

### Example 1

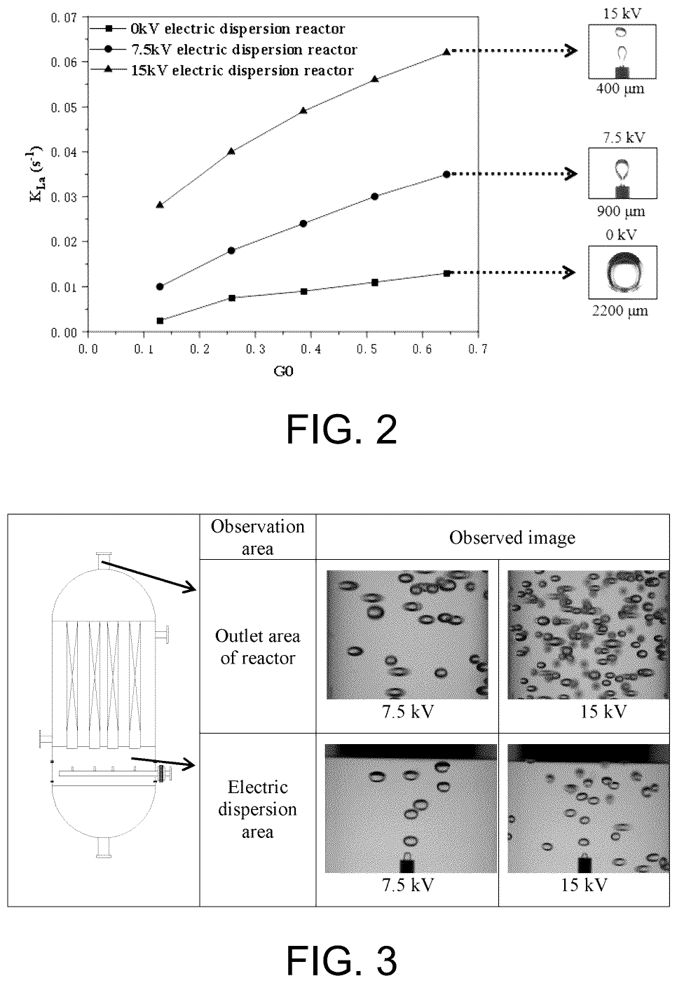

An oxygen mass transfer experiment is carried out in a reactor, and an electric dispersion reactor (i.e. a gas-liquid reactor of the present invention) and a traditional bubble tower reactor under different voltage are compared and analyzed. A row tube in the gas-liquid reactor has a tube diameter of 15 mm, the row tube is internally filled with a 3 mm glass spring packing, and a needle electrode has a hole diameter of 0.5 mm. The electric dispersion reactor and the traditional bubble tower reactor are both gas-liquid upflow states, a superficial gas velocity is 0.0008 m/s to 0.004 m/s and a superficial liquid velocity is 0.0001 m/s during passage of the row tube, and an experimental temperature is 20° C. An oxygen mass transfer coefficient K_{La} is measured with a dynamic oxygen concentration method. Oxygen mass transfer coefficients of the electric dispersion reactor under different voltages are shown in FIG. 2. When oxygen is dissolved in water by using the method and the device, the oxygen mass transfer coefficient of the electric dispersion reactor is improved from 0.0025 to 0.013 under 0 kV to 0.028 to 0.062 under 15 kV. Under the same operating condition, the traditional bubble tower reactor has the oxygen mass transfer coefficient ranging from 0.002 to 0.01, and the oxygen mass transfer coefficient of the traditional bubble tower reactor is equivalent to that of the electric dispersion reactor under 0 kV. The oxygen mass transfer coefficient of the electric dispersion reactor under 15 kV is at least 6.2 times of that of the bubble tower reactor.

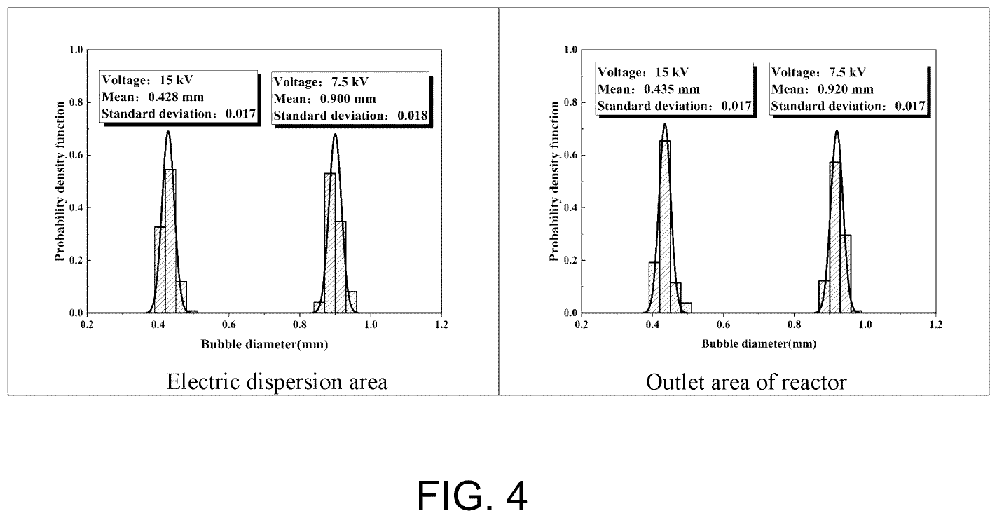

FIGS. 3 and 4 show bubble dispersion of the electric dispersion reactor in different regions and under different voltages, and specifically include a bubble image and a graph of particle size distribution at an electric dispersion area and an outlet of a reactor under 7.5 kV and 15 kV. It may be seen from a picture photographed in FIG. 3 that a dispersed particle size of the bubble is uniform, and there is basically no coalescence in each area. According to analysis of particle size distribution of the bubbles in FIG. 4, a particle size of the bubbles under electric dispersion is narrow peak distribution with a standard deviation ranging from 0.017 to 0.018, which further indicates that the particle size distribution of the bubbles is uniform, and the electric dispersion bubbles are controllable. Particle size distribution of the bubbles in the electric dispersion area is consistent with that in an outlet area of the reactor. Under 15 kV, an average particle size of the bubbles in the electric dispersion area is 0.428 mm, and an average particle size of the bubbles in the outlet area of the reactor is 0.435 mm; and under 7.5 kV, the average particle size of the bubbles in the electric dispersion area is 0.900 mm, and the average particle size of the bubbles in the outlet area of the reactor is 0.920 mm. It also shows that due to repulsion of the same charge, the bubbles may stably flow through the row tube, and there is basically no coalescence in each area.

### Example 2

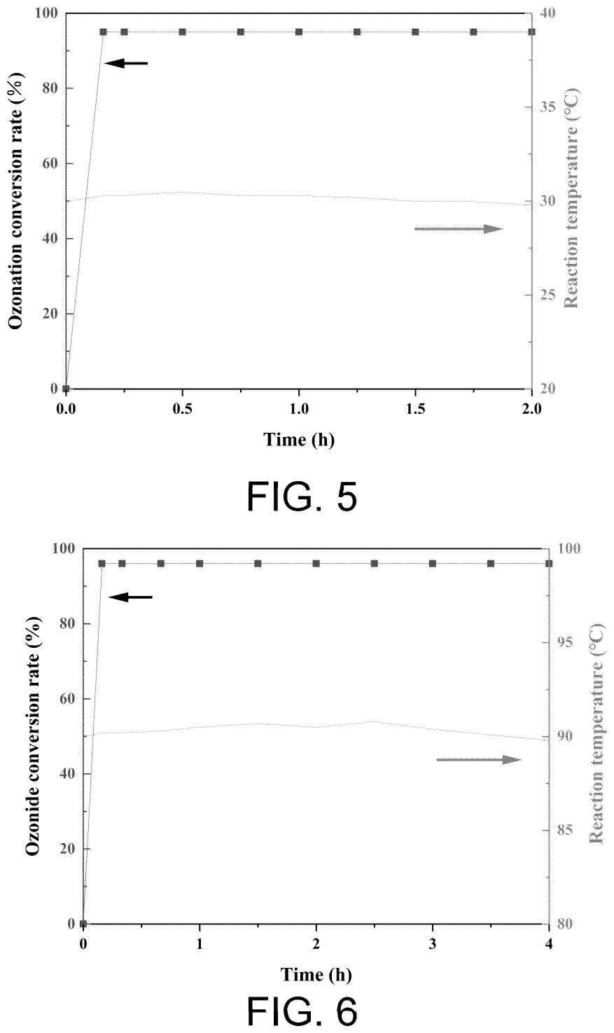

Reaction performance of the present invention is measured with an ozone oxidation oleic acid process. Process parameters of ozone oxidation are as follows: a reaction temperature is 30° C., a mass ratio of oleic acid to acetic acid is 1:4, an ozone flow rate is 20 g/h, an oleic acid-acetic acid mixed solution has a flow rate of 10 mL/min, and a superficial gas velocity is 0.002 m/s and a superficial liquid velocity is 0.0001 m/s during passage of a row tube. After dispersion, ozone fully reacts with the oleic acid-acetic acid mixed solution. Under the condition that a feeding temperature of a liquid raw material is 30° C., and a voltage applied to electric dispersion is 15 kV, an average particle size of a dispersed gas-phase material is measured by means of a high-speed camera to be around 400 microns. As shown in FIG. 5, results of ozone oxidation reaction in the electric dispersion reactor show that during a continuous reaction process of the electric dispersion reactor, an oleic acid conversion rate at a liquid outlet reaches and is maintained at 96% in a short period of time, and a reaction temperature is stabilized at 30° C.

### Example 3

Reaction performance of the present invention is measured with an oxygen oxidation cracking process. Process parameters of oxygen oxidation cracking are as follows: a reaction temperature is 90° C., a liquid product of ozone oxidation in Example 2 is used as a liquid raw material for oxygen oxidation cracking, an oxygen flow rate is 0.3 L/min, a liquid raw material flow rate is 10 mL/min, and a superficial gas velocity is 0.003 m/s and a superficial liquid velocity is 0.0001 m/s during passage of a row tube. After dispersion, oxygen fully reacts with a liquid raw material. Under the condition that a feeding temperature of a liquid raw material is 90° C., and a voltage applied to electric dispersion is 15 kV, an average particle size of a dispersed gas-phase material is measured by means of a high-speed camera to be around 400 microns. As shown in FIG. 6, results of oxygen oxidation reaction in the electric dispersion reactor show that during a continuous reaction process of the electric dispersion reactor, an oleic acid ozonide conversion rate at a liquid outlet reaches and is maintained at 96% in a short period of time, and a reaction temperature is stabilized at 90° C.

The results of the oleic acid ozone oxidation cracking reaction show that the present invention effectively enhances an oleic acid ozone oxidation cracking reaction process and a heat transfer process. In the continuous reaction process of the electric dispersion reactor, oleic acid and oleic acid odor ozonide reach and is maintained at a high conversion rate in a short period of time, the reaction temperature is stable, and a final yield of azelaic acid reaches 85% or above. The above examples show that the present invention may be configured to continuously produce oleic acid ozonation cracking to prepare azelaic acid.

The content of the description is only an enumeration of the implementation form of the invention concept, and the scope of protection of the present invention should not be limited to the specific forms stated in the examples.

What is claimed is:

1. A gas-liquid reactor, comprising: a reactor housing and a heat exchange jacket device arranged on an outer side of the reactor housing, wherein a bottom and a top of the reactor housing are provided with a liquid phase inlet and a gas-liquid phase outlet respectively, a lower end of a middle of the reactor housing is provided with a gas phase inlet, the lower end of the middle of the reactor housing is internally provided with an electric dispersion gas distributor in communication with the gas phase inlet, an upper surface of the electric dispersion gas distributor is provided with a plurality of needle electrodes, centers of the needle electrodes are provided with air holes, row tubes are arranged above the electric dispersion gas distributor, lower ends of the row tubes are grounded, the needle electrodes are connected to high-voltage electrodes, and a gas-phase material enters an internal cavity of the electric dispersion gas distributor from the gas phase inlet, is dispersed by the needle electrodes to be mixed with a liquid-phase material, then stably flows through the row tubes, and finally flows out through the gas-liquid phase outlet.

2. The gas-liquid reactor according to claim 1, wherein the electric dispersion gas distributor is in a circular tube type cavity structure, the needle electrodes are uniformly distributed on the upper surface of the electric dispersion gas distributor, the row tubes correspond to the needle electrodes one to one from top to bottom, and central axes of the row tubes and the needle electrodes that correspond to each other are located on the same vertical line.

3. The gas-liquid reactor according to claim 1, wherein the reactor housing comprises an upper sealing head, a middle housing and a lower sealing head, wherein the gas phase inlet is provided at a lower portion of a side wall of the middle housing, an insulating layer is arranged on each side wall of the middle housing above and below the gas phase inlet, and the insulating layer above the gas phase inlet is arranged between the high-voltage electrodes and a grounding electrode.

4. The gas-liquid reactor according to claim 1, wherein a diameter of each row tube is 5 times to 100 times a diameter of each needle electrode.

5. The gas-liquid reactor according to claim 1, wherein each row tube and each needle electrode are made of conductive metals.

6. The gas-liquid reactor according to claim 1, wherein each row tube is internally filled with a packing.

7. The gas-liquid reactor according to claim 3, wherein the heat exchange jacket device comprises a heat exchange interlayer arranged on an outer side of the middle housing, wherein a lower end and an upper end of the heat exchange interlayer are provided with a heat exchange medium inlet and a heat exchange medium outlet respectively.
